(19) United States
(12) Patent Application Publication
(10) Pub. No.: US 2012/0012553 A1
(43) Pub. Date: Jan. 19, 2012

(54) METHOD OF FORMING FIBROUS LAMINATE CHIP CARRIER STRUCTURES

(75) Inventors: Robert M. Japp, Vestal, NY (US); Kostas I. Papathomas, Endicott, NY (US); Cheryl Palomaki, Endicott, NY (US)

(73) Assignee: Endicott Interconnect Technologies, Inc., Endicott, NY (US)

(21) Appl. No.: 12/837,584

(22) Filed: Jul. 16, 2010

(51) Int. Cl. B32B 38/10; C23F 1/02

(52) U.S. Cl. 216/18; 156/256

(57) ABSTRACT

A method for making a leadless chip carrier (LCC) for use in electronic packages having a core layer stripped of copper cladding, containing drilled clearance holes within, a layer of resin coated copper (RCC) placed on the upper surface of the core layer and a second layer of RCC placed on the lower surface of the core layer. The layers are laminated together with the RCC filling the clearance holes during lamination. A pattern is etched on the RCC and vias are drilled through the filled clearance holes and pre-plated with seed copper layers. The seed copper layers in the vias are then covered by a layer of copper plating to meet the requirements of the core buildup layer, and resin inhibiting conductive anodic filament (CAF) growth within the structure.

### FIELD OF THE INVENTION

This invention relates to processes for forming core substrates and particularly to those used in multilayered circuit boards, leadless chip carriers, and the like. More particularly, the invention relates to manufacturing cores used in such final products so as to provide same with increased ground and power plane insulation resistance.

### BACKGROUND OF THE INVENTION

The needs of the semiconductor marketplace continue to drive density into semiconductor packages. Traditionally, greater wiring densities have been achieved by reducing the dimensions of vias, lines, and spaces, increasing the number of wiring layers, and utilizing blind and buried vias. However, each of these approaches, for example, those related to drilling and plating of high aspect ratio vias, reduced conductance of narrow circuit lines, and increased cost of fabrication related to additional wiring layers, includes inherent limitations.

PCBs, chip carriers and related products used in many of today's technologies must include multiple circuits in a minimum volume or space. Typically, such products comprise a “stack” of layers of signal, ground and/or power planes separated from each other by at least one layer of electrically insulating dielectric material. The circuit lines or pads (e.g., those of the signal planes) are often in electrical contact with each other by plated holes passing through the dielectric layers. The plated holes are often referred to as “vias” if internally located, “blind vias” if extending a predetermined depth within the board from an external surface, or “plated-thru-holes” (hereinafter also referred to simply as PTHs) if extending substantially through the board's full thickness. The term “thru-hole” as used herein is meant to include all three types of such board openings.

Complexity of these products has increased significantly in recent years. PCBs for mainframe computers may have as many as thirty-six layers of circuitry or more, with the complete stack having a thickness of as much as about 0.4 inch (400 mils). These boards are typically designed with three or five mil wide signal lines and twelve mil diameter thru-holes. Increased circuit densification requirements seek to reduce signal lines to a width of two mils or less and thru-hole diameters to two mils or less. Many known commercial procedures, especially those of the nature described herein, are incapable of economically forming these dimensions now desired by the industry. Such processes typically comprise fabrication of separate innerlayer circuits (circuitized layers), which are formed by coating a photosensitive layer or film over the copper layer of a copper clad innerlayer base material. The photosensitive coating is imaged and developed and the exposed copper is etched to form conductor lines. After etching, the photosensitive film is stripped from the copper, leaving the circuit pattern on the surface of the innerlayer base material. This processing is also referred to as photolithographic processing in the PCB art and further description is not deemed necessary.

After the formation of the individual innerlayer circuits, a multilayer stack is formed by preparing a lay-up of core innerlayers, ground planes, power planes, etc., typically separated from each other by a dielectric prepreg comprising a layer of glass (typically fiberglass) cloth impregnated with a partially cured material, typically a B-stage epoxy resin. The top and bottom outer layers of the stack usually comprise copper clad, glass-filled epoxy planar substrates with the copper cladding comprising the exterior surfaces of the stack. The stack is laminated to form a monolithic structure using heat and pressure to fully cure the B-stage resin. The stack so formed typically has metal (usually copper) cladding on both of its exterior surfaces. Exterior circuit layers are formed in the copper cladding using procedures similar to the procedures used to form the innerlayer circuits. A photosensitive film is applied to the copper cladding. The coating is exposed to patterned activating radiation and developed. An etchant is then used to remove copper bared by the development of the photosensitive film. Finally, the remaining photosensitive film is removed to provide the exterior circuit layers.

The aforementioned thru-holes (also often referred to as interconnects) are used in many such substrates to electrically connect individual circuit layers within the structure to each other and to the outer surfaces. The thru-holes typically pass through all or a portion of the stack. Thru-holes are generally formed prior to the formation of circuits on the exterior surfaces by drilling holes through the stack at appropriate locations. Following several pre-treatment steps, the walls of the holes are catalyzed by contact with a plating catalyst and metallized, typically by contact with an electroless or electrolytic copper plating solution to form conductive pathways between circuit layers. Following formation of the conductive thru-holes, exterior circuits, or outerlayers are formed using the procedure described above.

The necessity of developing ever-increasing high speed circuitized substrates for use in many of today's new products has led to the exploration of new materials to extend the electrical and thermal performance limits of the presently available technology. For high-speed applications, it is necessary to have extremely dense conductor circuitry patterning on low dielectric constant insulating material. Prepreg laminates for conventional circuit boards consist of a base reinforcing glass fabric impregnated with a resin, also referred to by some in the industry as “FR-4” dielectric material. Epoxy/glass laminates used in some current products typically contain about 40% by weight fiberglass and 60% by weight epoxy resin.

The presence of fiberglass within the multilayered structure, especially woven fiberglass, also substantially impairs the ability to form high quality, very small thru-holes using laser drilling (ablation), one of the preferred means to form such thru-holes. Fiberglass cloth has drastically different absorption and heat of ablation properties than typical thermo-set or thermo-plastic matrix resins. In a typical woven glass cloth, for example, the density of glass a laser might encounter can vary from approximately zero percent in a window area to approximately fifty percent by volume or even more, especially in an area over a cloth “knuckle.” This wide variation in encountered glass density leads to problems obtaining the proper laser power for each thru-hole and may result in wide variations in thru-hole quality, obviously unacceptable by today's very demanding manufacturing standards.

Fiberglass presence also often contributes to an electrical failure mode known as conductive anodic filament (CAF) growth. CAF growth often results in a time dependent electrical shorting failure that occurs when metal filaments grow along an interface (typically a glass fiber/epoxy resin interface), creating an electrical path between two features which should remain electrically isolated. Whether continuous (like woven cloth) or semi-continuous (like chopped fiber mattes), fiberglass strand lengths are substantial in comparison to the common distances between isolated internal features. Thus, these fibers can be a significant detractor for PCB insulation resistance reliability. While the use of glass mattes composed of random discontinuous chopped fibers (in comparison to the longer fibers found in continuous structures) can largely obviate the problem of inadequate laser drilled thru-hole quality, such mattes still contain fibers with substantial length compared to internal board feature spacing and, in some cases, offer virtually no relief from the problem of this type of growth.

CAF growth is a type of electrochemical migration (ECM) that consists primarily of metallic conductive salts being transported across a nonmetallic substrate under the influence of an applied electric field. In standard FR-4 laminate materials, electrochemical migration failures within PWBs have been characterized as CAF leakage paths forming along the glass fiber reinforcement at the epoxy-fiberglass interface due to chemical hydrolysis of the silane coupling agent. Sufficient moisture/vapor pressure, but not voltage bias or current, is necessary for the first stage in forming of these leakage paths. The second stage of conductive anodic filament growth then occurs when a voltage potential or bias voltage is applied.

CAF growth between plated-through holes or from a PTH to an otherwise isolated plane layer, trace, or other feature is also affected by mechanical stresses causing delamination that promotes formation of CAF leakage paths along the interfaces of glass fibers within the polymer matrix. These mechanical stresses can originate from the initial drilling of a PTH and may include some glass fibers being disrupted within the epoxy polymer matrix surrounding the hole perimeter, a CTE mismatch during thermal cycling, etc. Electrical failures caused by CAFs may occur when the filament grows until it reaches the cathode, resulting in a short circuit.

The mechanism by which CAF formation and growth occurs is first a physical degradation of the glass/epoxy bond. Moisture absorption then occurs under high humidity conditions. This creates an aqueous medium along the separated glass/epoxy interface that provides an electrochemical pathway and facilitates the transport of corrosion products. Electrochemical corrosion results because the water acts as the electrolyte, the copper circuitry becomes the anode and cathode, and the bias voltage serves as the driving potential.

Generating hydronium ions at the anode and hydroxide ions at the cathode creates a pH gradient between these electrodes. In the region of pH 7 to 11, copper is passivated and corrosion will not occur. However with a pH below 7, corrosion will occur at potentials greater than 0.2V. In the case of CAF formation, electrochemical reactions generate hydronium ions at the anode, causing the local pH to drop and corrosion products to become soluble. The copper ions created at the anode travel along the epoxy/fiber interface and are attracted to the cathode. However, at a pH above 5, the solubility of copper ions declines rapidly becoming nearly insoluble at about pH 8.6. When the copper ions become insoluble, they are deposited on the interface. The metallic copper-bearing filament known as CAF is formed from copper salt ions. The filament may initially grow in a random manner, but as time progresses, the growth direction of the filament is toward the cathode. When contact is made, electrical failure occurs.

It is believed that the invention represents a significant advancement in the art.

It is a primary object of the invention to enhance the art of creating high insulation resistance circuitized substrates.

It is another object to provide improved dielectric insulation resistance which can be used to form a core layer within a circuitized substrate and which can be produced successfully using conventional manufacturing procedures.

According to another object of the invention, there is provided a method of making a circuitized substrate, which comprises providing a copper coated multifunction epoxy on a Thermount reinforcement core.

According to one object of the invention, there is provided a method of making a core substrate that further comprises laminating the pretreated Thermount core with DC/Silica RCC layers.

### DISCUSSION OF RELATED ART

U.S. Pat. No. 6,930,258 by Kawasaki et al., issued Aug. 15, 2005 for MULTILAYER PRINTED WIRING BOARD AND METHOD OF PRODUCING MULTILAYER PRINTED WIRING BOARD and U.S. Pat. No. 7,178,234 by Kawasaki et al., issued Feb. 20, 2007, for METHOD OF MANUFACTURING MULTI-LAYER PRINTED CIRCUIT BOARD disclose a method for making through holes that are formed to penetrate a core substrate and lower interlayer resin insulating layers, and via holes that are formed right on the through holes, respectively. Due to this, the through holes and the via holes are arranged linearly, thereby making it possible to shorten wiring length and to accelerate signal transmission speed.

United States Published Patent Application No. 2010/0006328, published Jan. 10, 2010, by Kawasaki et al., for MULTI-LAYER PRINTED CIRCUIT BOARD AND METHOD OF MANUFACTURING MULTI-LAYER PRINTED CIRCUIT BOARD discloses a multi-layer printed circuit board having interlayer resin insulating layers on both sides of a core substrate, respectively, through holes provided to penetrate the core substrate and filled with resin filler, the interlayer resin insulating layers and conductor circuits provided. The resin filler contains an epoxy resin, a curing agent and 10 to 50% of inorganic particles. This application is a continuation-in-part of the aforementioned U.S. Pat. No. 7,178,234.

U.S. Pat. No. 7,078,816 by Japp et al., issued Jul. 18, 2006 for CIRCUITIZED SUBSTRATE discloses a circuitized substrate comprising a first layer comprising a dielectric material including a resin material with a predetermined quantity of particles therein and not including continuous fibers, semi-continuous fibers or the like as part thereof, and at least one circuitized layer positioned on the dielectric first layer.

U.S. Pat. No. 7,470,990 by Japp et al., issued Jul. 18, 2006 for LOW MOISTURE ABSORPTIVE CIRCUITIZED SUBSTRATE WITH REDUCED THERMAL EXPANSION, METHOD OF MAKING SAME, ELECTRICAL ASSEMBLY UTILIZING SAME, AND INFORMATION HANDLING SYSTEM UTILIZING SAME discloses a circuitized substrate including a composite layer including a first dielectric sub-layer with a plurality of fibers having a low coefficient of thermal expansion and a second dielectric sub-layer of a low moisture absorptivity resin. The second dielectric sub-layer does not include continuous or semi-continuous fibers. The substrate further includes at least one electrically conductive layer.

U.S. Pat. No. 6,944,946 by Japp, et al., issued Sep. 25, 2005 for POROUS POWER AND GROUND PLANES FOR REDUCED PCB DELAMINATION AND BETTER RELIABILITY discloses power and ground planes that are used in PCBs that comprise porous, conductive materials. Using porous power and ground plane materials in PCBs allows liquids (e.g., water and/or other solvents) to pass through the power and ground planes, thus decreasing failures in PCBs (or PCBs used as laminate chip carriers) caused by cathodic/anodic filament growth and delamination of insulators. Porous conductive materials suitable for use in PCBs may be formed by using metal-coated organic cloths (such as polyester or liquid crystal polymers) or fabrics (such as those made from carbon/graphite or glass fibers), using metal wire mesh instead of metal sheets, using sintered metal, or making metal sheets porous by forming an array of holes in the metal sheets. Fabrics and mesh may be woven or random. If an array of holes is formed in a metal sheet, such an array may be formed with no additional processing steps than are performed using conventional PCB assembly methods.

U.S. Pat. No. 6,323,439 by Kambe, et al., issued Nov. 27, 2001 for METAL CORE MULTILAYER RESIN WIRING BOARD WITH THIN PORTION AND METHOD FOR MANUFACTURING THE SAME discloses a multilayer resin wiring board including a metal core substrate having a first main surface and a second main surface; a plurality of wiring layers located on the first and second main surfaces of the metal core substrate; a plurality of insulating resin layers, each intervening between the metal core substrate and the wiring layers and between the metal core substrate and the wiring layers and between the wiring layers; and a via formed on the wall of a through hole for connection to the metal core substrate extending through the insulating resin layers and the metal core substrate so as to establish electrical conductivity to the metal core substrate. The metal core substrate has a thin portion that is thinner than the remaining portion of the metal core substrate. The through hole for connection to the metal core substrate is formed through the thin portion by laser machining.

U.S. Pat. No. 5,837,155 by Inagaki, et al., issued Nov. 17, 1998 for INSULATING RESIN COMPOSITION FOR BUILD-UP BY COPPER FOIL LAMINATION AND METHOD FOR PRODUCTION OF MULTILAYER PRINTED CIRCUIT BOARD USING THE COMPOSITION discloses an insulating resin composition for the build-up of multilayer circuits by the procedure of copper foil lamination and a method for the production of a multilayer printed circuit board by the use of the insulating resin composition. The insulating resin composition comprises at least one species of epoxy resin having a softening point of not more than 110 degrees C., a monomer or an oligomer possessing an unsaturated double bond, an epoxy resin-curing agent, and a photo polymerization initiator. The insulating resin composition is applied to a printed circuit board throughout the entire area thereof so as to cover conductor patterns formed thereon and then irradiated with UV light. Subsequently a copper foil is superposed on the applied layer of the insulating resin composition by means of a heated pressure roller to effect lamination thereof. The insulating resin composition is thermally cured to give a multilayer laminate and then the outer layer copper foil of the produced multilayer laminate is selectively etched to form a prescribed conductor pattern.

The previously disclosed United States issued patents and applications fail to adequately describe or disclose the present invention's increased insulation resistance reliability.

### SUMMARY OF THE INVENTION

According to the present invention, there is provided a method of making a laminated chip carrier core substrate that comprises laminating a pretreated P-aramid paper core containing clearance holes with DC/Silica resin coated copper (RCC) layers. The fiber-less resin is forced into the clearance holes. Subsequent processing adds plated through holes (PTH) located inside of the clearance holes. A reduction in insulation resistance failures occurs between PTHs and power and/or ground planes.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 is a sectional view of the prior art leadless chip carrier;

FIGS. 2-9 show sequential steps required to produce the LCC of the invention; and

FIG. 10 shows an alternate embodiment of the current invention.

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. For the sake of clarity and brevity, like elements and components of each embodiment will bear the same designations throughout the description.

### DESCRIPTION OF THE PREFERRED EMBODIMENT

The invention is a process for forming laminate chip carriers which allows fibrous containing laminates to be used within the structure, affording the benefit offered by fiber reinforced materials such as flexibility and strength, while preventing the fibers contained within the laminate from contributing to insulation resistance failures.

For a better understanding of the present invention, together with other and further objects, advantages and capabilities thereof, reference is made to the following disclosure and appended claims.

By the term “circuitized substrate” as used herein is meant a substrate product including one or more dielectric layers and one or more electrically conductive layers. Such products as known in the art include printed circuit boards (a/k/a printed wiring boards) and cards, and chip carriers (substrates adapted for having one or more electronic components such as a semiconductor chip mounted thereon). Typically, the conductive layers comprise copper or copper alloy. Previously known dielectric materials include the aforementioned, perhaps the most widely known being the described FR-4 fiberglass reinforced resin material. Examples of both such products are described in detail in the foregoing patents and other known documentation and further description is not believed necessary.

Arlon 55 NT™ is a combination of multifunctional epoxy (Tg 180° C.) on DuPont Type 4N-710 and/or type N-740#80 Series non-woven aramid reinforcement with a resin content of 63%. This material is designed for performance reliability with various interconnect packages: ball grid array (BGA), thin small outline package (TSOP), fine pitch surface mount technology (FP-SMT), and where conventional substrates are prone to solder joint cracking under thermal and power cycling due to CTE mismatch of the mounted devices.

The circuitized substrates produced with dielectric layers taught herein are adapted for use in many electronic products, perhaps the best known of these being what may be referred to as “information handling systems.” As used herein, this term shall mean any instrumentality or aggregate of instrumentalities primarily designed to compute, classify, process, transmit, receive, retrieve, originate, switch, store, display, manifest, measure, detect, record, reproduce, handle or utilize any form of information, intelligence or data for business, scientific, control or other purposes. Examples include personal computers and larger processors such as computer servers and mainframes. Such products are well known in the art and are also known to include PCBs and other forms of circuitized substrates as part thereof, some including several such components depending on the operational requirements thereof.

A particular use for the individual dielectric layers formed using this invention is to become parts of circuitized substrates such as chip carriers or PCBs or other electronic packaging products, including those produced and sold by the Assignee of this invention, Endicott Interconnect Technologies, Inc. The invention is of course not limited to chip carriers or even to higher level PCBs. It is also understood that such dielectric layers may be used to form what are referred to in the substrate art as “cores,” a specific example a “power core” if the core includes one or more power planes and is thus to serve primarily in this capacity. Like other conductive-dielectric layered substrates, such cores may in turn be stacked up with other layers, including conductors and dielectrics, and bonded together, preferably using conventional PCB lamination processing, to form a multilayered carrier or multilayered PCB. As also mentioned above, the laminate so formed is then subjected to further processing, including conventional photolithographic processing, to form circuit patterns on the outer conductive layers thereof. Such external patterns can include conductive pads on which conductors such as solder balls can be positioned to connect the structure to other components such as semiconductor chips, PCBs and chip carriers if so desired. The unique teachings of this invention are thus adaptable to a multitude of electronic packaging products.

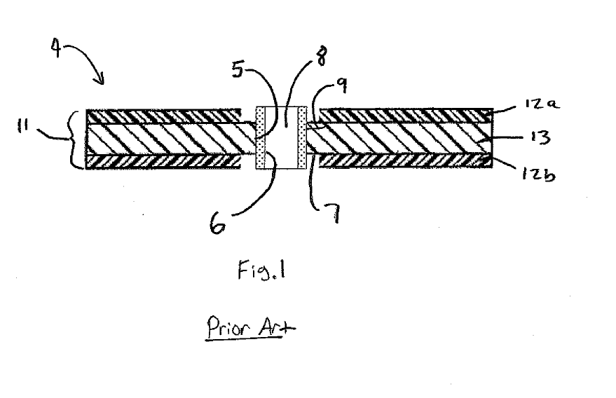

Referring now to FIG. 1, a prior art leadless chip carrier 4 is shown. A metal coated P-aramid paper core 11 with two metal planes 12a and 12b containing a pattern 7, 9, respectively, to insulate plated thru-hole 8 from coming into contact with the copper planes 12a and 12b. Pattern 7 is etched into the metal planes 12a and 12b using processes well known in the art and will not be further described. After the metal planes are etched, PTH 8 is created, again, using processes well known in the art such as laser or mechanical drilling. A thru-hole 5 is formed in laminate core 13 and then further plated 6 to create a PTH 8 to allow a power, ground, or other electronic signal to traverse the core layer 11. When using a fiber containing laminate, there can be CAF growth as described previously, shown as path 9, that can cause electrical leakage between PTH 8 and metal plane 12a as shown in this embodiment, a potentially destructive condition.

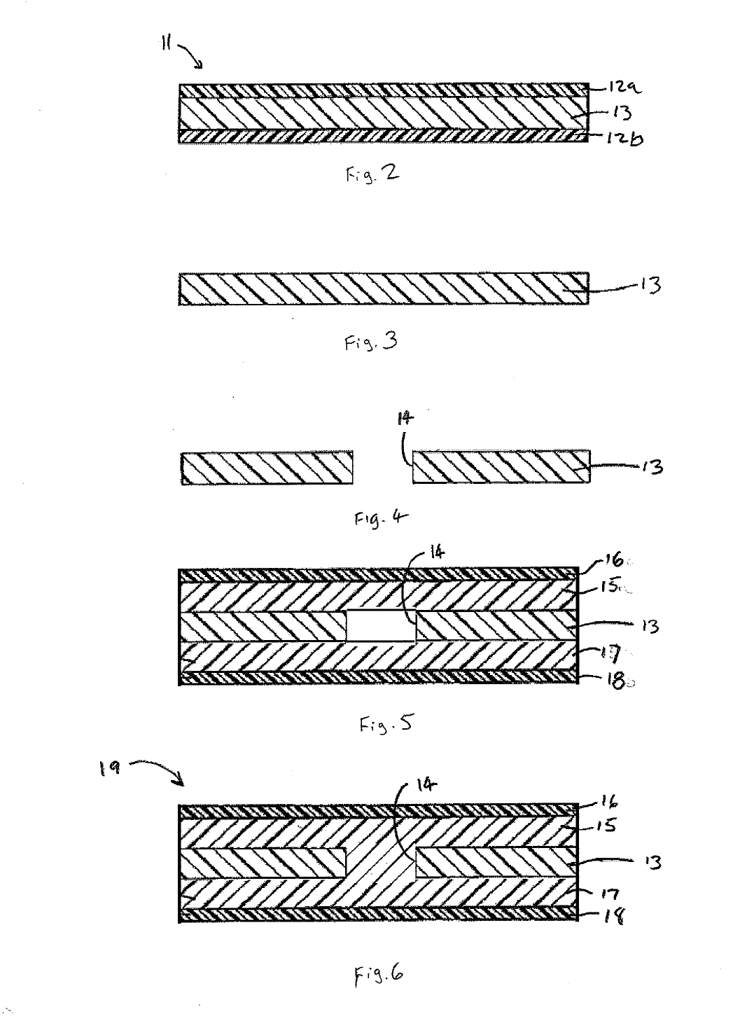

Referring now to FIGS. 2-4, there is shown a metal-coated P-aramid paper core 11 with two metal planes 12a and 12b surrounding laminate core 13, similar to FIG. 1. The two metal planes 12a and 12b are removed, leaving laminate core 13 available for further processing. A clearance hole 14 is created, again, using processes well known in the art, such as laser or mechanical drilling.

Referring now to FIGS. 5 and 6, the laminate core 13 containing clearance hole 14 is layered on both surfaces with a DC/Silica resin coated copper (RCC) consisting of resin 15, 17 and copper coating 16, 18, respectively, and laminated together as shown in FIG. 6 to create the interim laminated structure 19. The lamination process forces resin and silica filler 15, 17 into the clearance hole 14 to create a solid section of resin within clearance hole 14. The resin used for this process is known for its excellent insulation and resistance properties.

Referring now to FIGS. 7-9, the interim laminated structure 19 is further processed with pattern 7 being etched into the copper planes 16 and 18 using processes well known in the art. After the copper planes are etched, thru-hole 5 is created, again, using processes well known in the art such as laser or mechanical drilling, to create a thru-hole completely within the clearance hole 14 in laminate core 13. This thru-hole 5 is further plated 6 to create PTH 8 to allow a power, ground, or other electronic signal to traverse the laminate core 13 while minimizing the possibility of CAF growth that will result in a pathway opening between PTH 8 and copper planes 16 and 18 or PTH 8 and an adjacent PTH (not shown).

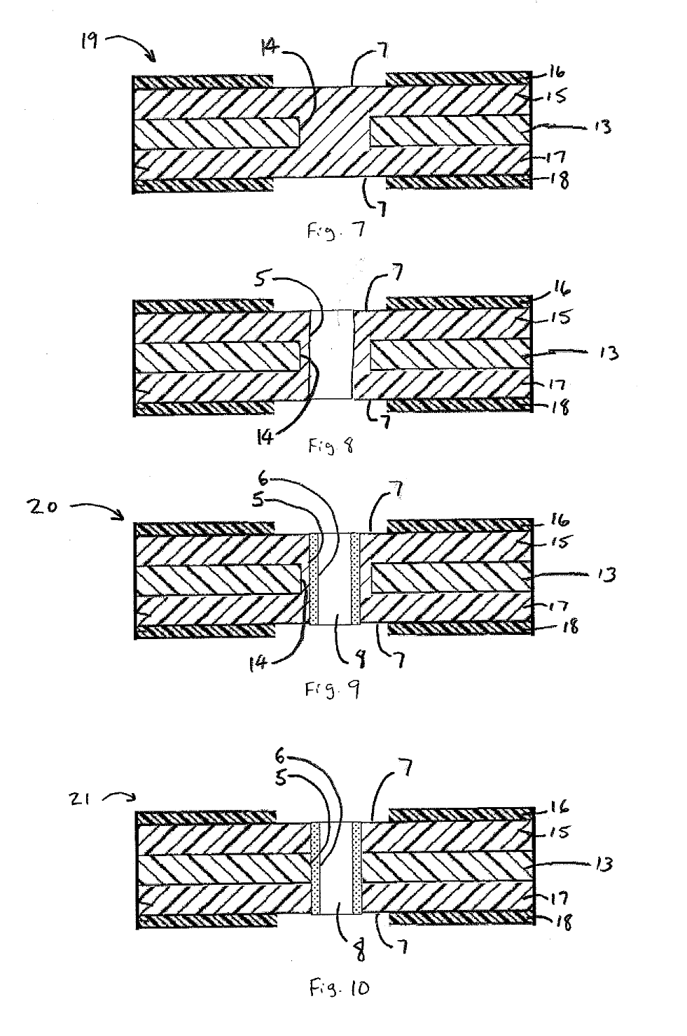

Referring now to FIG. 10, there is shown an alternate embodiment 21 of the current invention that does not contain the clearance hole 14 in laminate core 13, but contains PTH 8 that is in contact with the laminate core 13 further insulated from the copper planes 16, 18 by the layers of resin 15, 17 that are resistant to fiber CAF growth. This structure may suffer from PTH to PTH leakage, due to the laminate core 13 being susceptible to fiber CAF growth but will not support CAF from the PTH to the power plane since all fiber pathways have been eliminated. While theoretically this embodiment is not as efficient a barrier to CAF growth and resultant insulation resistance failure between power, signal, and ground planes as the previously described embodiment, it is superior to the prior art structure of FIG. 1 at stopping CAF growth and has proven satisfactory in testing and use.

While there have been shown and described what are at present considered to be the preferred embodiments of the invention, it will be obvious to those skilled in the art that various changes and modifications may be made therein without departing from the scope of the invention as defined by the appended claims.

Since other modifications and changes to the improved insulation resistance effected as such will be apparent to those skilled in the art, the invention is not considered limited to the description above for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of forming a laminated chip carrier (LCC) for use in electronic packages, the steps comprising:
a) providing a non-woven laminate having an upper copper surface and a lower copper surface;
b) removing said upper and said lower copper surfaces to form a core layer having an upper surface and a lower surface;
c) forming a clearance hole in said core layer;
d) disposing a first layer of dielectric having a copper coated upper side and a lower side on said upper surface of said core layer;
e) disposing a second layer of dielectric having an upper side and a copper coated lower side on said lower surface of said core layer; and
f) laminating all of said layers together, forming a first subassembly having a top and a bottom surface, wherein said first and said second layers of copper coated dielectric fill in said clearance hole.

2. The method of forming an LCC for use in electronic packages as in claim 1, the steps further comprising:
g) etching a pattern in said top and said bottom surfaces of said first subassembly;
h) forming a via within said clearance hole through said first subassembly, said via being isolated from said non-woven laminate; and
i) depositing a layer of copper in said via.

3. The method of forming an LCC as in claim 1, wherein said core layer comprises P-aramid paper material.

4. The method of forming an LCC as in claim 2, wherein said forming said via step (h) further comprises pre-plating said via by a conventional cleaning process and depositing a seed copper layer therein.

5. The method of forming an LCC as in claim 1, wherein said first and said second layers of copper coated dielectric comprise DC/Silica resin coated copper (RCC).

6. The method of forming an LCC as in claim 1, wherein said forming said clearance hole step (c) is accomplished using at least one type of laser from the group: UV, IR, and Nd-YAG.

7. The method of forming an LCC as in claim 2, wherein said forming said via step (h) is accomplished using at least one type of laser from the group: UV, IR, and Nd-YAG.

8. The method of forming an LCC as in claim 2, wherein said etching a pattern step (g) comprises etching a pattern from on at least one of the group: power plane and ground plane.

9. A method of forming a laminated chip carrier (LCC) for use in electronic packages, the steps comprising:
a) providing a non-woven laminate having an upper copper surface and a lower copper surface;
b) etching a clearance hole pattern in said upper copper surface of said non-woven laminate;
c) forming a hole in said clearance hole pattern on said non-woven laminate;
d) removing said upper and said lower copper surfaces to form a core layer having an upper surface and a lower surface;
e) disposing a first layer of dielectric having a copper coated upper side and a lower side on said upper surface of said core layer;
f) disposing a second layer of dielectric having an upper side and a copper coated lower side on said lower surface of said core layer; and
g) laminating all of said layers together, forming a first subassembly having a top and a bottom surface, wherein said first and said second layers of copper coated dielectric fill in said clearance hole.

10. The method of forming an LCC for use in electronic packages as in claim 9, the steps further comprising:
h) etching a pattern in said top and said bottom surfaces of said first subassembly;
i) forming a via within said clearance hole through said first subassembly, said via being isolated from said non-woven laminate; and
j) depositing a layer of copper in said via.

11. The method of forming an LCC as in claim 9, wherein said core layer comprises P-aramid paper material.

12. The method of forming an LCC as in claim 10, wherein said forming said via step (i) further comprises pre-plating said via by a conventional cleaning process and depositing a seed copper layer therein.

13. The method of forming an LCC as in claim 9, wherein said first and said second layers of copper coated dielectric comprise DC/Silica resin coated copper (RCC).

14. The method of forming an LCC as in claim 9, wherein said forming said hole step (c) is accomplished using at least one type of laser from the group: UV, IR, and Nd-YAG.

15. The method of forming an LCC as in claim 10, wherein said forming said via step (i) is accomplished using at least one type of laser from the group: UV, IR, and Nd-YAG.

16. The method of forming an LCC as in claim 10, wherein said etching a pattern step (h) comprises etching a pattern from on at least one of the group: power plane and ground plane.

17. A method of forming a laminated chip carrier (LCC) for use in electronic packages, the steps comprising:
a) providing a non-woven laminate having an upper copper surface and a lower copper surface;
b) removing said upper and said lower copper surfaces to form a core layer having an upper surface and a lower surface;
c) disposing a first layer of dielectric having a copper coated upper side and a lower side on said upper surface of said core layer;
d) disposing a second layer of dielectric having an upper side and a copper coated lower side on said lower surface of said core layer;
e) laminating all of said layers together, forming a first subassembly having a top and a bottom surface;
f) etching a pattern in said top and said bottom surfaces of said first subassembly;
g) forming a via through said first subassembly; and
h) depositing a layer of copper in said via.

18. The method of forming an LCC as in claim 17, wherein said core layer comprises P-aramid paper material.

19. The method of forming an LCC as in claim 17, wherein said forming said via step (g) further comprises pre-plating said via by a conventional cleaning process and depositing a seed copper layer therein.

20. The method of forming an LCC as in claim 17, wherein said first and said second layers of copper coated dielectric comprise DC/Silica resin coated copper (RCC).

21. The method of forming an LCC as in claim 17, wherein said forming said via step (g) is accomplished using at least one type of laser from the group: UV, IR, and Nd-YAG.

22. The method of forming an LCC as in claim 17, wherein said etching a pattern step (f) comprises etching a pattern from on at least one of the group: power plane and ground plane.
